(19) United States
(12) Patent Application Publication
(10) Pub. No.: US 2006/0278078 A1
(43) Pub. Date: Dec. 14, 2006

(54) Methods and systems for generation of gases

(76) Inventors: Thorstein Holt, Chesterfield, MO (US); Gary Winkler, St. Louis, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 11/440,904

(22) Filed: May 25, 2006

Related U.S. Application Data
(60) Provisional application No. 60/684,510, filed on May 25, 2005.

(51) Int. Cl. B01D 53/02

(52) U.S. Cl. 95/138

(57) ABSTRACT

A method of operating a nitrogen generator is provided, wherein the method includes providing a source of compressed air and operating a plurality of pneumatic valves with the compressed air. The method also includes operating at least one pneumatic timer to toggle the nitrogen generator between a production mode where compressed air is channeled to a nitrogen adsorber to produce nitrogen, and a regeneration mode where substantially oxygen-rich air in the nitrogen adsorber is exhausted into the atmosphere.

### CROSS REFERENCE TO RELATED APPLICATIONS

This application claims the benefit of U.S. provisional application No. 60/684,510 filed May 25, 2005, which is herein incorporated by reference in its entirety.

### BACKGROUND OF THE INVENTION

This invention relates generally to generators, and more specifically to pressure-swing-adsorption (PSA) nitrogen generators. Herein, the generators are generally referred to as nitrogen generators. However the disclosed embodiments also apply to generators of other gases, such as oxygen, methane, etc.

Nitrogen is used for many applications. The most common general application is taking advantage of its inert property, typically to keep oxygen away from combustible products or products that degrade with exposure to oxygen and/or moisture. Systems are known that utilize combusted fossil fuel to produce a mixture consisting of approximately 88% N2 and 12% CO2 for use as an inert gas. However, the presence of CO2 caused a problem for many applications. Cryogenic (approx −320F) liquid nitrogen (LN2) has became increasingly available and has replaced most of the earlier nitrogen generators. Later, pressure swing adsorption (PSA) was commercialized, making it possible to produce high purity nitrogen at facilities, including remote locations. This alleviated the need to have LN2 tanks, piping, dependence on LN2 suppliers etc. PSA also eliminated heavy losses of nitrogen product due to heat transfer, and the hazards of handling cryogenic fluid.

PSA systems use a carbon molecular sieve (CMS), which adsorbs oxygen and other molecules much more readily than nitrogen molecules. A bed of CMS in a pressure vessel is pressurized with standard compressed air. The CMS adsorbs the oxygen, while nitrogen flows through a port typically located in the opposite end from the compressed air inlet.

After a certain length of time (2 minutes for example), the CMS has adsorbed about as much oxygen as it has capacity to adsorb. At that point, the purity of the nitrogen diminishes, as more and more oxygen molecules make their way through the CMS bed to the nitrogen outlet. Typical PSA systems use two CMS adsorber vessels. Vessel ‘A’ is pressurized and producing nitrogen, while vessel ‘B’ is depressurized and “regenerated”, similar to a regenerative dessicant air dryer. After a predetermined time period, valves are switched, so that vessel ‘B’ is pressurized and produces nitrogen, while vessel ‘A’ is regenerated. This is typically controlled by electromechanical timers, or via a programmable logic controller (PLC).

### BRIEF DESCRIPTION OF THE INVENTION

In one aspect, a method of operating a nitrogen generator is provided, wherein the method includes providing a source of compressed air and operating a plurality of pneumatic valves with the compressed air. The method also includes operating at least one pneumatic timer to toggle the nitrogen generator between a production mode where compressed air is channeled to a nitrogen adsorber to produce nitrogen, and a regeneration mode where substantially oxygen-rich air in the nitrogen adsorber is exhausted into the atmosphere.

In another aspect, a nitrogen generator is provided, wherein the nitrogen generator includes a source of compressed air, a plurality of pneumatic valves operated by the compressed air and configured to channel the compressed air, and a nitrogen adsorber fluidly coupled to at least one of the plurality of pneumatic valves. The nitrogen generator also includes at least one pneumatic timer to toggle said nitrogen generator between a production mode and a regeneration mode, wherein, during the production mode, the compressed air operates the plurality of pneumatic valves such that at least one pneumatic valve channels the compressed air to the nitrogen adsorber to produce nitrogen and, during the regeneration mode, the compressed air operates the plurality of pneumatic valves such that at least one pneumatic valve exhausts substantially oxygen-rich air in the nitrogen adsorber into the atmosphere.

In a further aspect, a nitrogen adsorber is provided, wherein the nitrogen adsorber includes a first end, a second end and a body extending therebetween. The body includes a carbon molecular sieve to remove oxygen from compressed air and a desiccant material to remove water from the compressed air.

### BRIEF DESCRIPTION OF THE DRAWINGS

FIG. 1 is a schematic of a pneumatic control system.

FIG. 2 is a cross-sectional view of an adsorber vessel that may be used with the system shown in FIG. 1.

FIG. 3 is an illustration of internal components of the adsorber vessel shown in FIG. 2.

### DETAILED DESCRIPTION OF THE INVENTION

Described herein are methods and apparatus that reduce cost and complexity, and improve performance, of pressure swing adsorbtion (PSA) nitrogen generators. The ability to control timing of a control system is provided with a pneumatic system that obviates the need for a programmable logic controller (PLC) or electromechanical timer, and allows operation of the system without requiring electricity. Variants of the system described herein are used for dual bed PSA systems. However the primary application is for single bed (monobed) PSA systems. Also provided is a method of constructing vessels designed for easy maintenance and low cost as is a method of obtaining quality flow distribution of gas in a space-efficient and cost-effective manner.

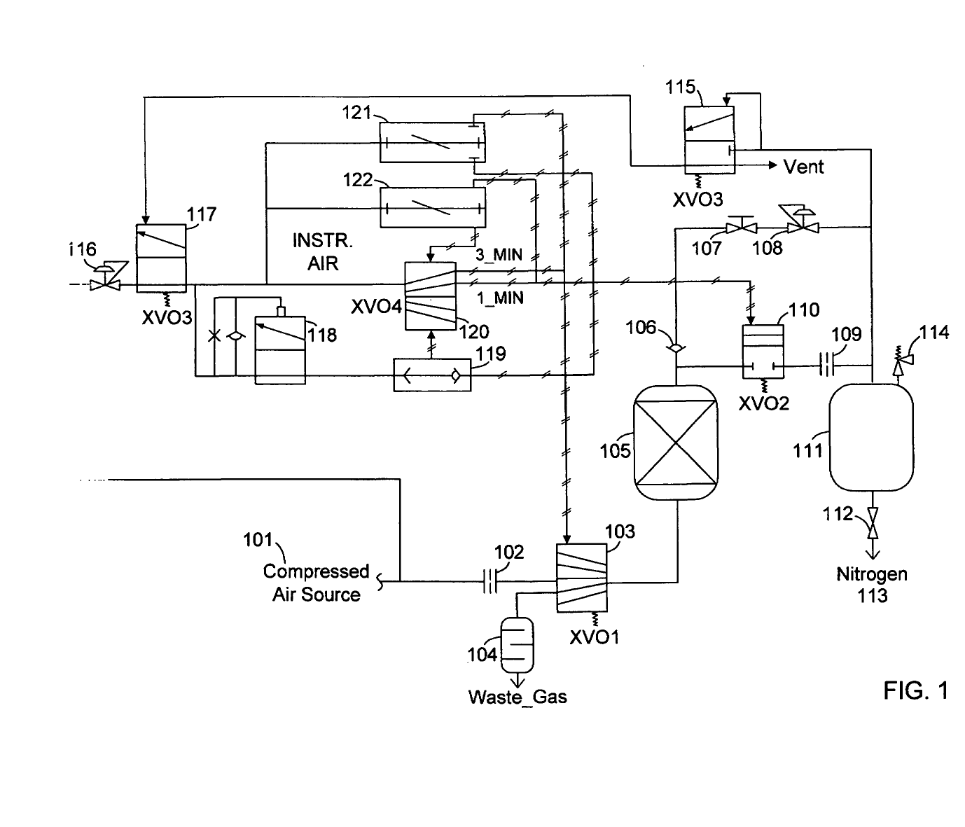

FIG. 1 is a block diagram of a time control system 100. As shown in FIG. 1, compressed air, 101, is supplied to system 100. A small amount of compressed air diverts to a pressure regulator 117, which reduces pressure downstream of 117 to, for example, 80 psig. In the preferred embodiment, valve 117 is a pneumatically operated spring return valve which supplies pressure to a timer circuit when pressure is not being supplied via a pressure switch 115. Pressure switch 115 in the preferred embodiment is a spring operated compressor unloaded valve, but may be a pneumatic or electrically operated pressure switch. When a nitrogen receiver tank 111 is “full” (at desired storage pressure), switch 115 stops applying pressure to valve 117, and energizes the timer circuit.

Pneumatic timers 121 and 122 allow independent control of production and regeneration time for an adsorber vessel 105. Timers 121 and 122 may be a single device, electromechanical, or other types of timers, however in the preferred embodiment timers 121 and 122 are fully pneumatic devices with an adjustable valve control dial that regulates a length of time prior to switching output.

A pulse valve 118 and a shuttle valve 119 start the system in the regeneration mode. This may be accomplished alternately by spring-loading valve 120 or other means. Adsorber 105 may be started in production cycle, however starting in the production cycle is not recommended for optimal carbon life and performance.

When valve 117 has first supplied pressure to the circuit, a pulse valve 118 supplies pressure for a small length of time (one second for example). This switches shuttle valve 119 to position A, applying pressure to valve 120, labeled in FIG. 1 as port 14 for descriptive purposes. This passes pressure to port ‘B’ of valve 120, applying pressure to valve 110, which allows nitrogen to flow through, or “purge”, adsorber vessel 105. This nitrogen purge flow is an optional feature that improves system performance. An orifice 109 is a fixed orifice in the preferred embodiment, but may also be a throttling valve or a length and diameter of tubing that will give the desired flow rate for a given system design.

The amount of nitrogen purge flow, as a function of nitrogen production, is an important variable. In one embodiment, the purge/production ratio is less than 0.05. Additional variables such as carbon molecular sieve (CMS) type, operating pressure, adsorber geometry will all affect the purge/production ratio.

The essential feature of the regeneration mode is that valve 103 is in the position that exhausts adsorber 105 contents into the atmosphere. These contents are oxygen-rich air. The oxygen and other molecules desorb from the CMS when pressure is removed. The optional flow nitrogen described above assists in flushing oxygen from the CMS.

Once the proper regeneration time has expired, for example one minute, timer 122 switches and passes air from its power port to its output port. Switching of timer 122 passes pressure to valve 120 port 12, which allows pressure to be applied to a valve 103. This starts the “production” cycle which allows compressed air to enter adsorber 105. Nitrogen-rich gas flows past the CMS, through a check valve 106, a flow control valve 107, and a backpressure regulator 108. When a sufficient backpressure is achieved, for example 100 psig, regulator 108 begins to open and fill nitrogen receiver 111.

Once timer 121 switches to allow pressure to flow from power port to output port, pressure is applied to shuttle valve 119, which switches valve 120, initiating the regeneration cycle and the cycle repeats. This continues until pressure switch 115 reaches its setpoint, and applies pressure to valve 117, which allows the timing circuit to exhaust and deenergize. This indicates that the nitrogen receiver is full, and stops generation of nitrogen to conserve compressed air.

A primary advantage of this system is the elimination, in the preferred embodiment, of electric power. This obviates the need for an electrician and the expense and inconvenience of wiring in typical locations. It also can allow operation in a remote site or one with non-standard voltage where a compressor is present, but possibly not a generator or supply of power. The system can safely be operated in hazardous areas where combustible gases may be present.

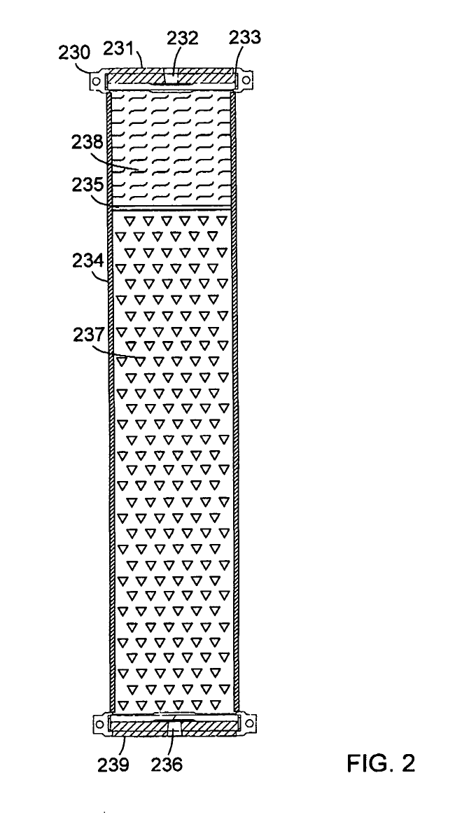

FIG. 2 is a schematic view of an adsorber vessel that may be used with system 100. The vessel consists of a pipe or tube, 234, which retains the internal pressure. The wall thickness of tube 234 is determined in accordance with well known hoop stress equations. A top head 231 and a bottom head 239 also serve to retain pressure, and are designed similarly per well known head equations.

The vessel also includes a top piping port 232 and a bottom piping port 236. Ports 232 and 236 can be piped with normal production flow coming in the top, and flowing downward to the bottom, or reversed. In either case, flow reverses during the regeneration cycle.

A CMS bed 237 performs the separation of nitrogen and argon from other constituents in the air, which is described above. A desiccant material 238, typically activated alumina, retains free water in the compressed air to prevent it from reaching the CMS material. Water degrades CMS and prevents oxygen from being retained. During the regeneration cycle, desiccant material 238 is also regenerated. A thin sheet of inert material 235 separates CMS bed 237 and dessicant material 238. In one embodiment, material 235 is a fibrous mat material which is sometimes colloquially referred to as “coconut”. Components used in this construction consist of inexpensive and off-the-shelf pipe, end-caps, and clamps. Welding and costly machining is eliminated, compared to known designs.

One of the features of this monobed construction style, in addition to the use of only one vessel versus the typical use of two vessels, is the combination of CMS and desiccant in the same vessel. Known systems use a separate vessel for the desiccant. This feature significantly reduces system complexity, cost and size.

Another cost-reduction feature is the use of clamp fittings 230 that retain heads 231 and 239. The preferred embodiment are clamp fittings used in fire sprinkler systems, manufactured by Victaulic Co., Anvil Corp. (Gruvlok™), and others. These clamp fittings use a rubber or other elastomer seal, compressed by the fitting, to provide an airtight seal, depicted by item 233. Grooves cut or rolled into the pipe and head allow the clamp to retain the heads. These fittings provide significant cost reduction compared with the typical use of ANSI flanges. In addition, they provide a method of quick access into the contents of the adsorber vessel, reducing labor during fabrication and maintenance operations. ANSI flanges take many more large bolts (typically 4, 8, 12, 16 or more bolts per closure). Typically desiccant must be changed every 3-4 years, while the CMS can last a decade or more. The clamps also typically have a smaller diameter than ANSI flanges, allowing more compact system packaging.

Another feature described herein is the placement of desiccant 238 on top of CMS bed 237. The placement of desiccant allows the more frequent changing of the desiccant material to be performed without disturbing the CMS or removing the adsorber vessel. The desiccant is typically removed utilizing a vacuum device. Conversely it is possible to turn the vessel over from the preferred orientation and remove the CMS while leaving desiccant intact, on the less frequent occasions where this is necessary.

An additional benefit of this construction is that there is not a requirement for welding. This allows fabrication without the need for a welding machine or operator. It also obviates the need for welding qualifications and inspection of welds and certain construction codes. These aspects significantly reduce construction costs.

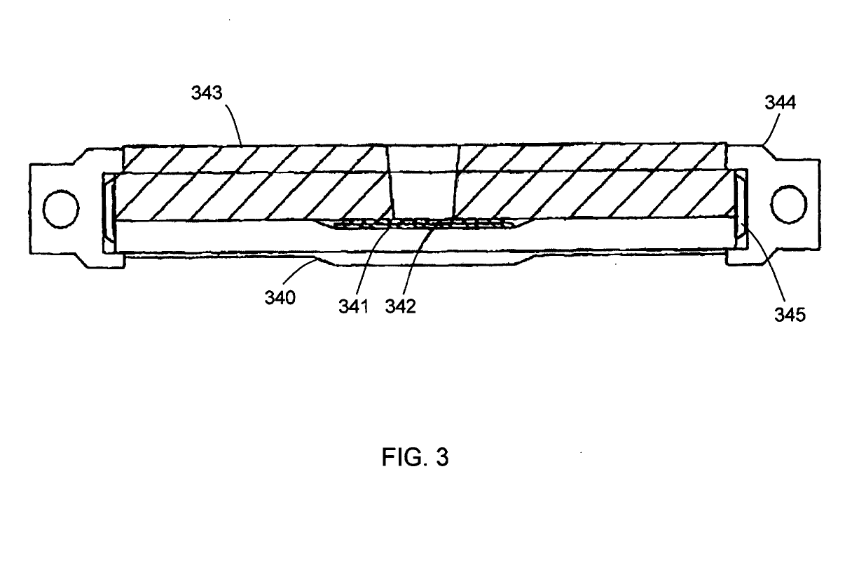

FIG. 3 is a close-up cross-section of the head region illustrated in FIG. 2. Item 344 is the clamp, and 343 is the head. Item 340 is a thick section of the previously described “coconut” material (or other inert material). This material serves as a gas-distribution system, allowing the material to distribute evenly across the cross-sectional area without excessive pressure drop. The means presently known in the field typically involve a complex assembly of metal standoffs and perforated fabricated assemblies. These other designs typically use a much more significant volume. The embodiments disclosed herein, by comparison, improve air consumption efficiency.

Still referring to FIG. 3, a mesh screen 342 prevents CMS and/or desiccant material from flowing into the process piping, which would cause damage to other components, and degradation of the adsorber performance. Item 341 is a perforated plate with holes larger than screen 342. Plate 341 is typically sheet metal, but may be of plastic or other materials. Items 341 and 342 may be a single device with perforations. However, it is believed that the use of two devices lends to superior performance, where item 342 catches fine particles, but item 341 blocks larger particles, helping to keep screen 342 from clogging. Item 341 is firmly attached to head 343, by tack-welding, screws, rivets, or other common means.

The primary result of the embodiments described herein is the production of a low-cost efficient means for producing nitrogen. The means disclosed herein greatly reduce the cost of producing systems with small capacity. There are many markets with a need for low cost, reliable units. These include tire inflation, food preservation (displacing oxygen which degrade food), beverage production, especially alcohol, beverage dispensing, blanketing of tanks that have chemicals and petroleum products, and many others. In addition, the embodiments described herein enables nitrogen generators to be effective and productive in many more markets by reducing costs and eliminating the requirement for electrical power.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Although the apparatus and methods described herein are described in the context of a carbon molecular sieve (CMS) and a pressure-swing-adsorption (PSA) nitrogen generator, it is understood that the apparatus and methods are not limited to CMS or PSA nitrogen generators. Likewise, the CMS and PSA nitrogen generator components illustrated are not limited to the specific embodiments described herein, but rather, components of the CMS and PSA nitrogen generator can be utilized independently and separately from other components described herein.

While the invention has been described in terms of various specific embodiments, those skilled in the art will recognize that the invention can be practiced with modification within the spirit and scope of the claims.

What is claimed is:

1. A method of operating a nitrogen generator, said method comprising:
providing a source of compressed air;
operating a plurality of pneumatic valves with the compressed air; and
operating at least one pneumatic timer to toggle the nitrogen generator between a production mode where compressed air is channeled to a nitrogen adsorber to produce nitrogen, and a regeneration mode where substantially oxygen-rich air in the nitrogen adsorber is exhausted into the atmosphere.

2. A method of operating a nitrogen generator in accordance with claim 1 further comprising channeling nitrogen to a nitrogen tank during the production mode.

3. A method of operating a nitrogen generator in accordance with claim 1 further comprising purging the nitrogen adsorber by channeling nitrogen therethrough.

4. A method of operating a nitrogen generator in accordance with claim 3 wherein the nitrogen adsorber has a purge/production ratio indicative an amount of nitrogen purge flow as a function of nitrogen production, and the purge/production ratio is less than 0.05.

5. A method of operating a nitrogen generator in accordance with claim 1 further comprising stopping the production of nitrogen when a pressure switch achieves a predetermined pressure.

6. A method of operating a nitrogen generator in accordance with claim 1 further comprising:
removing oxygen from the compressed air with a carbon molecular sieve retained within the nitrogen adsorber; and
removing water from the compressed air with a desiccant material retained within the nitrogen adsorber.

7. A method of operating a nitrogen generator in accordance with claim 6 wherein the regeneration mode further comprises:
restoring oxygen removing properties of the carbon molecular sieve; and
restoring water removing properties of the desiccant material.

8. A nitrogen generator comprising:
a source of compressed air;
a plurality of pneumatic valves operated by the compressed air and configured to channel the compressed air;
a nitrogen adsorber fluidly coupled to at least one of said plurality of pneumatic valves; and
at least one pneumatic timer to toggle said nitrogen generator between a production mode and a regeneration mode, wherein, during the production mode, the compressed air operates said plurality of pneumatic valves such that at least one pneumatic valve channels the compressed air to said nitrogen adsorber to produce nitrogen and, during the regeneration mode, the compressed air operates said plurality of pneumatic valves such that at least one pneumatic valve exhausts substantially oxygen-rich air in said nitrogen adsorber into the atmosphere.

9. A nitrogen generator in accordance with claim 8 further comprising a nitrogen tank, wherein, during the regeneration mode, the compressed air operates said plurality of pneumatic valves such that at least one pneumatic valve channels nitrogen from said nitrogen adsorber to said nitrogen tank.

10. A nitrogen generator in accordance with claim 8 wherein the compressed air operates said plurality of pneumatic valves such that at least one pneumatic valve purges said nitrogen adsorber by channeling nitrogen therethrough.

11. A nitrogen generator in accordance with claim 10 wherein said nitrogen adsorber has a purge/production ratio indicative of an amount of nitrogen purge flow as a function of nitrogen production, and the purge/production ratio is less than 0.05.

12. A nitrogen generator in accordance with claim 8 further comprising a pressure switch to stop the production of nitrogen when a predetermined pressure is achieved.

13. A nitrogen generator in accordance with claim 8 wherein said nitrogen adsorber comprises:
a carbon molecular sieve to remove oxygen from the compressed air; and
a desiccant material to remove water from the compressed air.

14. A nitrogen generator in accordance with claim 8 wherein said nitrogen adsorber comprises a body, a first end and a second end, said first end and said second end are clamped to said body and sealed to said body with an elastomer material.

15. A nitrogen adsorber comprising:
a first end, a second end and a body extending therebetween, said body comprising:
a carbon molecular sieve to remove oxygen from compressed air; and
a desiccant material to remove water from the compressed air.

16. A nitrogen adsorber in accordance with claim 15 wherein said desiccant material comprises activated alumina.

17. A nitrogen adsorber in accordance with claim 15 wherein said first end and said second end are clamped to said body and sealed to said body with an elastomer material.

18. A nitrogen adsorber in accordance with claim 15 further comprising an inert material separating said carbon molecular sieve and said desiccant material.

19. A nitrogen adsorber in accordance with claim 15 wherein, after exposure to the compressed air, said carbon molecular sieve restores oxygen removing properties and said desiccant material restores water removing properties.

20. A nitrogen adsorber in accordance with claim 15 wherein at least one of said first end and said second end are removable from said body such that at least one of said carbon molecular sieve and said desiccant material can be replaced.
